(19) United States
(12) Patent Application Publication
(10) Pub. No.: US 2021/0298130 A1
(43) Pub. Date: Sep. 23, 2021

(54) METHOD OF MANUFACTURING AN ELECTRIC HEATER AND ELECTRIC HEATER

(71) Applicant: Türk & Hillinger GmbH, Tuttlingen (DE)

(72) Inventor: Andreas SCHLIPF, Tuttlingen (DE)

(21) Appl. No.: 17/189,925

(22) Filed: Mar. 2, 2021

(30) Foreign Application Priority Data
Mar. 4, 2020 (DE) 10 2020 105 782.2
Oct. 5, 2020 (EP) 20 200069.1

(51) Int. Cl. H05B 3/44; B21D 51/16

(52) U.S. Cl. CPC H05B 3/44; B21D 51/16

(57) ABSTRACT

Disclosed is a method for producing an electrical heating device with an electrical heating element, which is arranged in the interior of a multi-part tubular metal jacket embedded in an electrically insulating material, wherein the electrical heating device has, within the multi-part tubular metal jacket, on at least one end, an unheated area, in which, during operation of the electrical heating device, electrical current flows at least also through at least one connection wire, and/or at least one connection sleeve and/or at least one connection pin, which is in electrical contact with the electrical heating element, and further has a heated area, in which, during operation of the electrical heating device, electrical current flows only through a section of the electrical heating element running in the heated area. An electrical heating device with a multi-part tubular metal jacket, which can be produced with this method, is also disclosed.

### CROSS-REFERENCE TO RELATED APPLICATION

This application claims priority under 35 U.S.C. § 119 to German Patent Application No. 10 2020 105 782.2, filed on Mar. 4, 2020, and European Patent Application No. 20 200069.1, filed Oct. 5, 2020, the disclosures of which are incorporated herein by reference in their entireties.

### BACKGROUND OF THE INVENTION

Electrical tubular heating elements are a variant of electrical heating devices that have been known for many years. They are distinguished in that the electrical heating element is arranged inside a tubular metal jacket, wherein it is electrically insulated in the radial direction relative to the tubular metal jacket by being embedded in an electrically insulating, but good heat-conducting material, in many cases, e.g., magnesium oxide, boron nitride, or Al₂O₃, each in the form of a powder or granulate or also a porous molded body made from, in particular, one of these materials, in order to prevent undesired short circuits. Furthermore, in many cases the electrical heating device is compressed.

In many applications of electrical tubular heating elements, it is desired that the electrical tubular heating elements have an unheated area on one end at least on one of its sides. To provide this, it is known to produce the connection to the electrical heating element by a connection wire and/or connection pin, which has a greater cross section than the electrical heating element and can be inserted, for example, in the case of a connection wire, into the coiled interior of the electrical heating element or, in the case of a connection pin, can receive an end section of the electrical heating element.

In addition to the larger cross section of the connection pin, in many cases the heat occurring in the area of the connection pin is here reduced by selecting a material with a lower specific resistance than that of the material, from which the heating element is produced, for example, by the use of copper or nickel as a material for the connection pin.

Especially for applications in which the available installation space is low, however, this known procedure produces a series of problems. First, the connection wire and/or connection pin prevents the filling of the electrically insulating material. Second, the unheated area of the electrical heating device constructed in this way can be compressed only with much difficulty, because only a small amount of the electrically insulating material is present in this section in the cross section, so that an essentially solid structure made from the connection wire and/or connection pin and a section of the electrical heating element must be compressed to form essential parts. This leads to huge loads on the compression machines and short downtime of the compression systems and their molds.

### BRIEF SUMMARY OF THE INVENTION

The problem of the invention is therefore to disclose an improved method for producing an electrical heating device and an electrical heating device that can be produced with such a method. Depending on the construction, in particular, the invention can achieve individual improvements or improvements in combination with each other with respect to
the possibility for housing the largest possible conductor cross section in the unheated area,
optimal compression in all areas, which takes into account, in particular, a different cross-sectional reduction due to different porous components of different area,
the solution of filling problems,
a cost optimization through economical production that can be automated to a very high degree for the heated area,
a cost optimization through production that can be automated or that can be largely automated for unheated areas of a desired or needed length,
the possibility of using materials for connection wires, connection sleeves, or connection pins, which have melting points below the annealing temperature, despite annealing processes being required for the production of the heated area—for example, if the electrical heating device is soft-annealed so that it is bendable,
a high degree of process assurance,
and/or a reduction of the loading of compression machines and their molds.

This problem is solved by a method with the features described herein and in the claims and an electrical heating device with the features described herein and in the claims. Advantageous refinements of the invention are the subject matter of the respective dependent claims.

The method according to the invention is used for producing an electrical heating device with an electrical heating element, which is arranged in the interior of a multi-part tubular metal jacket embedded in an electrically insulating material, i.e., electrically insulated (e.g., by embedding in an electrically insulating powder or granulate or by electrically insulating molded parts), wherein the electrical heating device has, within the multi-part tubular metal jacket, on at least one end, an unheated area, in which, during operation of the electrical heating device, electrical current flows at least also through at least one connection wire and/or at least one connection sleeve and/or at least one connection pin, which is in electrical contact with the electrical heating element.

Here, the unheated area can have, in particular, preferably an unheated transition area, in which, during operation of the electrical heating device, electrical current flows simultaneously both through the at least one connection wire and/or the at least one connection sleeve and/or the at least one connection pin, and also through a section of the electrical heating element running in the unheated transition area, wherein this section of the electrical heating element is in electrical contact with the connection wire or connection pin. In other words, in the unheated transition area, there is a section of the electrical heating element and at least one section of a connection wire or a connection sleeve or a connection pin, wherein these sections are not technically connected in series, but instead in parallel.

Furthermore, the electrical heating device to be produced with the method has, within the multi-part tubular metal jacket, a heated area, in which, during operation of the electrical heating device, electrical current flows only through a section of the electrical heating element running in the heated area.

At this point it should be noted that it is neither excluded that the multi-part tubular metal jacket is used as a return conductor (because according to the condition specified above for the heated area, this must be within the multi-part tubular metal jacket) nor is it excluded that, for the electrical heating device, both connections are on the same side.

That the tubular metal jacket is multi-part means, in particular, that it is assembled from multiple parts—preferably multiple tube sections—which, however, are rigidly connected to each other, for example, can be compressed or welded together.

Furthermore, the term “unheated area” must be understood so that, despite the fact that heat can be generated in this area—which is unavoidable in most real embodiments and thus is actually the case—the generated heat is in a significantly smaller extent than in the heated area, in which the electrical heating device is designed to generate heat for fulfilling its intended function.

According to the method according to the invention, in a first method step, the heated area is created and compressed in a first part of the multi-part tubular metal jacket, in a second method step performed independently of and usually completed after the first method step, at least one section of the unheated area is produced in a second part of the multi-part tubular metal jacket and the first part and the second part of the multi-part tubular metal jacket are connected to each other. Because the second method step is usually performed at least partially after the first method step, it is given from this condition that the first part must naturally already be present for connecting the first part and the second part.

The step specified last can also be performed before or during, that is, at the same time as the compression of the second part of the tubular metal jacket, if such a compression step is provided. Thus it is not necessarily performed at the end of the second method step or after the second method step.

By dividing the production into two method steps, wherein the first method step delivers as an intermediate product at least the “finished” heated area and optionally a part of the unheated area and the second method step then produces the missing unheated area with an initially separate part of the tubular metal jacket, the compression processes for the individual parts of the electrical heating device can each be performed optimally. In particular, the compression of the heated area can be performed in a cutting method.

This measure also simultaneously significantly simplifies the respective filling with the electrically insulating material because the obstacle represented by the unheated area is eliminated.

The finished heated area present after the first method step can here correspond, in particular, to an electrical heating device with tubular metal jacket, in which, on the end side, connections of the electrical heating device projecting out of the tubular metal jacket are formed by a section of the electrical heating element, preferably with connection wire arranged thereon and/or connection sleeve arranged thereon, and thus the unheated transition section for the completely finished electrical heating device according to the invention.

In a preferred refinement of the method, in the first method step, the section running in the heated area, i.e., the section later forming the heated area, of the electrical heating element, is positioned in a first part of the multi-part tubular metal jacket; the electrically insulating material, e.g., as powder or as granulate or as a molded part, is inserted, that is, embedded, into this area of the first part of the multi-part tubular metal jacket, so that the section of the electrical heating element arranged in the first part of the multi-part tubular metal jacket is insulated by the electrically insulating material, and the first part of the multi-part tubular metal jacket, in particular, the heated area, is compressed.

At this point it should be noted that, on one hand, the specified method steps are preferably performed in this sequence, but, on the other hand, other method steps in the scope of the first method step can also be performed before, after, or between these steps.

In one preferred refinement of the invention, in the second method step performed after the first method step, at least one section of the unheated area including at least one part of the unheated transition area is created, in that a part of the electrical heating element with connection wire arranged thereon and/or connection sleeve arranged thereon and/or connection pin arranged thereon is inserted into a second part of the multi-part tubular metal jacket, wherein additional electrically insulating material is inserted, in particular, embedded, into the second part of the tubular metal jacket, so that the section of the electrical heating element arranged in the second tubular metal jacket is electrically insulated by the electrically insulating material. Preferably, the second part of the multi-part tubular metal jacket is then also compressed.

In this second method step, the specified method steps can preferably be performed in this sequence and additional processing steps in the scope of the second method step can also be performed before, after, or between these steps.

According to one preferred refinement of the method, in the first method step there is a connection wire in an electrically conductive connection with an end section of the electrical heating element, in particular, by being inserted into a coiled end section of the electrical heating element and/or a connection sleeve in an electrically conductive connection with an end section of the electrical heating element, in particular, by being pushed onto a coiled end section of the electrical heating element.

In both of the described cases, a (typically smaller) part of the transition area is also present within the first part of the multi-part tubular metal jacket, which has proven to be advantageous in terms of process assurance, especially with respect to the electrical contacting of the electrical heating element.

In one advantageous refinement of the method, the electrical heating element is coiled so that an end section of the electrical heating element has a smaller coil diameter than a section of the electrical heating element, which is in the heated area for the finished electrical heating device and is, in particular, preferably not an end section. This measure can contribute to simplifying the filling of the first part of the multi-part tubular metal jacket with the electrically insulating material.

This coiling of the electrical heating element is preferably already formed before the insertion into the first part of the multi-part tubular metal jacket.

In an especially effective way, the filling of the first part of the multi-part tubular metal jacket with the electrically insulating material can be simplified if the electrical heating element is coiled so that the end section of the electrical heating element has a smaller coil diameter than the section of the electrical heating element that is in the heated area in the finished electrical heating device, and has a coil axis running offset relative to the coil axis of the section of the electrical heating element in the heated area in the finished electrical heating device.

In many cases it can also be advantageous if, in the first method step after the compression, a connection-side section of the first part of the multi-part tubular metal jacket and layer of electrically insulating material radially adjacent to this part toward the inside is cut. As already mentioned, as a consequence of the production method according to the invention, the first part of the multi-part tubular metal jacket and the second part of the multi-part tubular metal jacket are subjected to different compression processes.

Due to the later cutting, a connection-side section of the first part of the multi-part tubular metal jacket and the layer of electrically insulating material adjacent radially to this part toward the inside can be pre-compressed, in particular, a section of the transition area arranged in the second part of the multi-part tubular metal jacket with the compression parameters that are applied to the first part of the multi-part tubular metal jacket and then compressed again with the compression parameters that are applied to the second part of the multi-part tubular metal jacket, which can have positive effects, especially for the quality of the electrical contact between the connection wire, connection sleeve, connection pin, and end section of the electrical heating element. In addition, the cutting can also contribute to creating a more homogeneous boundary surface or a more homogeneous transition between the electrically insulating material in the first part of the multi-part tubular metal jacket and the electrically insulating material in the second part of the multi-part tubular metal jacket.

Advantageously, after a section of the electrical heating element or a connection wire or connection pin was exposed by such a cutting step, a cleaning step is performed, in which the residue of insulation is removed, for example, by brushing, polishing, and/or ultrasonic treatment, in order to improve the quality of the electrical contact.

Another refinement of the method provides that the second part of the multi-part tubular metal jacket with an open cross section that can receive the outer contour of the end section of the first part of the multi-part metal jacket facing it at least after the compression in the first method step is pushed and fixed on this end section of the first part of the multi-part tubular metal jacket. In this way, any gaps between the first and the second part of the multi-part tubular metal jacket are avoided in an especially effective way. In addition, a larger open cross section makes it easier to fill the electrically insulating material in particular in the area with this cross section.

In the refinement just described it is especially useful if the second part of the multi-part tubular metal jacket is connected during the compression in the second method step by pressing together with the first part of the multi-part tubular metal jacket.

Advantageously, the second compression, if it is provided, is constructed so that, through the resulting axial compression pressure, a nearly homogeneous transition area is produced between the electrically insulating material in areas that were subjected to the first compression and in areas that were subjected to the second compression.

For applications in which it is important that the electrical heating device has a constant outer contour over its entire length, the cross section of the second part of the multi-part tubular metal jacket can be adapted to the cross section of the first part of the multi-part tubular metal jacket during compression in the second method step.

In an especially effective way, an unheated connection area can be constructed if, in the second method step before the insertion of the electrically insulating material, a part of the electrical heating element with the connection wire arranged thereon and/or connection sleeve arranged thereon is inserted from one side into the second part of the multi-part tubular metal jacket and a connection pin with an opening for receiving this part of the electrical heating element with the connection wire arranged thereon is inserted from the opposite side into the second part of the multi-part tubular metal jacket with the opening and is pushed onto this part of the electrical heating element.

In addition, in many cases in which a high-temperature treatment was previously required, which prevented, in particular, the use of connection wires and/or connection pin made from copper, this material can be used with the method according to the invention if at least one method step, in which the intermediate product on which this method step is performed is exposed to thermal loading and if at least the method step in which the highest thermal loading is performed is carried out before the beginning of the second method step.

The electrically insulating material that is brought into the second part of the multi-part tubular metal jacket can also be a molded part. In particular, it can also be useful to impregnate the electrically insulating material.

However, it is also possible to produce the second part of the multi-part tubular metal jacket such that extruded material is provided with a feedthrough that has an internal conductor electrically insulated from an outer tube made from metal in a desired length. This makes it possible, in a simple and economical way, to freely adapt the length of the unheated sections that are each needed to the respective application and can contribute to an especially economical, fully automated production of these unheated sections.

In particular, an internal conductor of this feedthrough, but also another internal conductor of a differently constructed second part, can be provided on the side facing the first part of the tubular metal jacket with an annular groove in a metal-cutting or drilling process, in order to provide the electrical contact to the internal conductor of the first part of the tubular metal jacket, that is, the electrical heating element, directly or by means of its connection wires, which can then be inserted, e.g., into the hole and can form a press contact, for example, by hexagonal crimping. However, thread could also be formed in such a hole and a connection wire or connection pin of the first part of the tubular metal jacket.

To produce the contact to an electrical supply line, a section facing this connection can be cut on the side of the second part of the tubular metal jacket facing away from the first part of the tubular metal jacket together with the layer of electrically insulating material radially adjacent to this section of the second part of the tubular metal jacket toward the inside.

Advantageously, a cleaning step is then also performed, in which residue of insulation is removed, for example, by brushing, polishing, and/or ultrasonic treatment, in order to improve the quality of the electrical contact.

Alternatively, however, an internal conductor of the second part of the tubular metal jacket surrounded by the tubular metal jacket can be drilled on the side facing the first part of the tubular metal jacket, in order to form an electrical contact for the connection of the supply line in the hole and a press contact can be formed, for example, by hexagonal crimping.

The connection between the first part of the tubular metal jacket and the second part of the tubular metal jacket can be created by welding or soldering at the end.

It is more advantageous, however, on one hand, because in this way an influence of the welding or soldering process by insulating material, in particular, MgO, is avoided, and, on the other hand, the penetration of moisture can be prevented as effectively as possible, if, while producing this connection, a ring is pushed onto the transition area between the first part and the second part of the tubular metal jacket and this is then welded or soldered on both sides.

Another variant for producing this connection provides that the end sections of the first part of the tubular metal jacket and the second part of the tubular metal jacket are each processed with metal cutting so that they overlap each other with an accurate fit and are then welded or soldered to each other. If the end section of the first or second part of the tubular metal jacket made thinner from the outside is longer than that of the end section of the second or first part of the tubular metal jacket overlapping this section, it can also be achieved that a weld seam or solder bead that projects beyond the outer diameter of the tubular metal jacket is avoided.

The electrical heating device according to the invention can be produced, in particular, according to a method according to the claimed invention, but does not absolutely have to be produced according to such a method.

It comprises, in particular, an electrical heating element, which is arranged electrically insulated, in particular, embedded, in the interior of a multi-part tubular metal jacket, which has a first part and a second part, in an electrically insulating material. Here, the electrical heating device has, within the multi-part tubular metal jacket
on at least one end, an unheated area, in which, during operation of the electrical heating device, electrical current flows at least also through at least one connection wire and/or at least one connection sleeve and/or at least one connection pin, wherein the at least one connection wire and/or the at least one connection sleeve and/or the at least one connection pin is in electrical contact with the electrical heating element, and
a heated area, in which, during operation of the electrical heating device, electrical current flows only through a section of the electrical heating element running in the heated area, wherein the heated area is arranged in the first part of the multi-part tubular metal jacket and the unheated area is arranged in the second part of the multi-part tubular metal jacket.

By dividing the tubular metal jacket into multiple parts, the compression processes can each be performed optimally for the individual parts of the electrical heating device. Simultaneously, this measure significantly simplifies the respective filling with the electrically insulating material.

Preferably, part of the unheated area is formed by an unheated transition area, in which, during operation of the electrical heating device, electrical current simultaneously flows both through the at least one connection wire and/or connection pin and also through a section of the electrical heating element running in the unheated transition area, which is in electrical contact with the connection wire and/or connection pin.

According to one preferred refinement, a connection wire is in an electrically conductive connection with an end section of the electrical heating element, which can be inserted, in particular, in a coiled end section of the electrical heating element.

Alternatively or additionally, a metal sleeve can be used as a connection sleeve in an electrically conductive connection with an end section of the electrical heating element and can be formed especially by pushing, soldering, or welding the connection sleeve on a coiled end section of the electrical heating element (12, 12′, 12″).

In both of the described cases, a (typically smaller) part of the transition area is also possibly present within the first part of the multi-part tubular metal jacket, which has proven advantageous for process assurance, especially with respect to the electrical contacting of the electrical heating element. The transition area, however, must extend into the second part of the multi-part tubular metal jacket.

Filling with the electrically insulating material can be simplified in that the electrical heating element is coiled such that an end section of the electrical heating element has a smaller coil diameter than a section of the electrical heating element in the heated area for the finished electrical heating device.

This effect is especially strong when the electrical heating element is coiled so that the end section of the electrical heating element, which has a smaller coil diameter than the section of the electrical heating element, which is in the heated area in the finished electrical heating device, has a coil axis that runs offset relative to the coil axis of the section of the electrical heating element, which is in the heated area in the finished electrical heating device.

The leak tightness of the multi-part tubular metal jacket is enhanced if the second part of the multi-part tubular metal jacket with an open cross section that can receive the outer contour of the end section of the first part of the multi-part metal jacket facing it at least after the compression in the first method step is pushed on this end section of the first part of the multi-part tubular metal jacket and fixed there.

Here, the cross section of the second part of the multi-part tubular metal jacket can be adapted by compression in the second method step to the cross section of the first part of the multi-part tubular metal jacket.

An especially effective design of the unheated area provides that a part of the electrical heating element with connection wire arranged thereon and/or connection sleeve arranged thereon is inserted from one side into the second part of the multi-part tubular metal jacket and a connection pin with an opening for receiving this part of the electrical heating element with connection wire arranged on the part of the electrical heating element and/or connection sleeve arranged thereon is inserted from the opposite side into the second part of the multi-part tubular metal jacket and is pushed on with the opening on this part of the electrical heating element.

It is especially preferred if the second part of the multi-part tubular metal jacket is formed from extruded material of a feedthrough, which has an internal conductor electrically insulated from an outer tube made from metal. This makes it possible to freely adapt the length of the unheated sections that are each needed to the respective application and can contribute to an especially economical, fully automated production of these unheated sections. In particular, an internal conductor of this feedthrough, but also a different internal conductor of a second part can be processed with metal cutting on the side facing the first part of the tubular metal jacket, provided or drilled with an annular groove, in order to provide the electrical contact to the internal conductor of the first part of the tubular metal jacket, that is, the electrical heating element, directly or by means of its connection wires, which are then inserted, e.g., into the hole and—a press contact is formed, for example, by hexagonal crimping. However, thread could also be formed in such a hole and a connection wire or connection pin of the first part of the tubular metal jacket.

To produce the contact to an electrical supply line, on the side of the second part of the tubular metal jacket facing away from the first part of the tubular metal jacket, a section facing this connection is cut together with the layer of electrically insulating material radially adjacent on the inside to this section of the second part of the tubular metal jacket.

Alternatively, however, an internal conductor of the second part of the tubular metal jacket surrounded by the tubular metal jacket can also be drilled on the side facing the first part of the tubular metal jacket and provided with an electrical contact inserted and pressed into the hole for the connection of the supply line.

The connection between the first part of the tubular metal jacket and the second part of the tubular metal jacket can be produced by welding or soldering on the ends.

This is advantageous, because, on one hand, it avoids any influence on the welding or soldering process by the insulating material, in particular, MgO, and, on the other hand, even if a ring is pushed on the transition area between the first part and the second part of the tubular metal jacket and welded or soldered on both sides, the penetration of moisture is effectively prevented as much as possible.

Another variant for producing this connection provides that the end sections of the first part of the tubular metal jacket and of the second part of the tubular metal jacket are each processed with metal cutting, so that they overlap each other with accurate fit and are then welded or soldered to each other. Here, if the end section of the first or second part of the tubular metal jacket made thinner from the outside is longer than that of the end section of the second or first part of the tubular metal jacket overlapping this part, it can also be achieved that a weld seam or solder bead that projects beyond the outer diameter of the tubular metal jacket is prevented.

### BRIEF DESCRIPTION OF THE SEVERAL VIEWS OF THE DRAWING

The foregoing summary, as well as the following detailed description of the preferred invention, will be better understood when read in conjunction with the appended drawings. For the purpose of illustrating the preferred invention, there are shown in the drawings embodiments which are presently preferred. It should be understood, however, that the invention is not limited to the precise arrangements and instrumentalities shown. In the drawings:

FIG. 1a is a side perspective, partially transparent view of one half of an embodiment of an electrical heating device in accordance with a preferred embodiment of the present invention;

FIG. 1b is a longitudinal cross-section through the representation of the electrical heating device of FIG. 1a;

FIG. 1c is a first detailed enlargement from FIG. 1b, taken from within a left-circle of FIG. 1b;

FIG. 1d is a second detailed enlargement from FIG. 1b, taken from within a right-circle of FIG. 1b;

FIG. 2 is a side perspective view of a section of the electrical heating device in a first intermediate state during the execution of a first method for producing the electrical heating device of FIG. 1a;

FIG. 3 is a side perspective view of the section of the electrical heating device of FIG. 1a in a second intermediate state during the execution of the first method for producing the electrical heating device of FIG. 1a;

FIG. 4 is a side perspective view of a section of the electrical heating device of FIG. 1a in a third intermediate state during the execution of the first method for producing the electrical heating device of FIG. 1a;

FIG. 5 is a side perspective view of a section of the electrical heating device of FIG. 1a in a fourth intermediate state during the execution of the first method for producing the electrical heating device of FIG. 1a, which shows an intermediate product obtained after the first method step;

FIG. 6 is a side perspective view of a section of the electrical heating device of FIG. 1a in a fifth intermediate state during the execution of the first method for producing an electrical heating device of FIG. 1a;

FIG. 7a is a cross-sectional view of a first design of an end section of the electrical heating element of FIG. 1a;

FIG. 7b is cross-sectional view of a second design of an end section of the electrical heating element of FIG. 1a;

FIG. 7c is a cross-sectional view of a third design of an end section of the electrical heating element of FIG. 1a;

FIG. 8a is a cross-sectional view of a first design of an unheated transition area of the electrical heating element of FIG. 1a;

FIG. 8b is a cross-sectional view of a second design of an unheated transition area of the electrical heating element of FIG. 1a;

FIG. 8c is a cross-sectional view of a third design of an unheated transition area of the electrical heating element of FIG. 1a;

FIG. 9a is a side perspective view of a section of a second embodiment of an electrical heating device before joining a first part and a second part of a tubular metal jacket of an electrical heating device in accordance with the second preferred embodiment of the present invention;

FIG. 9b is a longitudinal cross-sectional view through the illustration of the section of the second embodiment of the electrical heating device of FIG. 9a;

FIG. 9c is a magnified cross-sectional view of the longitudinal section from FIG. 9b after the joining of the first and the second part of the tubular metal jacket;

FIG. 9d is a magnified cross-sectional view of the longitudinal section from FIG. 9c after a local pressing process;

FIG. 9e is a magnified cross-sectional view of a cutout enlargement of the longitudinal section from FIG. 9c;

FIG. 9f is a magnified cross-sectional view of a cutout enlargement of the longitudinal section from FIG. 9d;

FIG. 10a is a side perspective view of a first variant of the section of the second embodiment of the electrical heating element from FIGS. 9a-f before the joining of the first part and the second part of the tubular metal jacket;

FIG. 10b is a cross-sectional view of the first variant of the embodiment according to FIG. 10a after the joining of the first and the second part of the tubular metal jacket;

FIG. 11 is a cross-sectional view of a second variant of the section of the second embodiment of the electrical heating element from FIG. 9a-f after the joining of the first and second part of the tubular metal jacket;

FIG. 12 is a cross-sectional view of a third variant of the section of the second embodiment of the electrical heating element from FIG. 9a-f after the joining of the first and second part of the tubular metal jacket;

FIG. 13a is a longitudinal cross-sectional view through a section of a third embodiment of an electrical heating device before the joining of the first and second part of the tubular metal jacket;

FIG. 13b is a cross-sectional view of the longitudinal section from FIG. 13a after the joining of the first and second part of the tubular metal jacket;

FIG. 13c is a cross-sectional view of the longitudinal section from FIG. 13b after a local pressing process;

FIG. 14 is a side elevational section view of a first intermediate state during the execution of a second method for producing an electrical heating device;

FIG. 15a is a cross-sectional, partially exploded view of a second intermediate state during the execution of the second method for producing the electrical heating device in a first variant;

FIG. 15b is a side perspective, partial cross-sectional, partially exploded view of the section from FIG. 15a in a second variant;

FIG. 16 is a magnified partial cross-sectional view of a section of a third intermediate state during the execution of the second method for producing the electrical heating device in the first variant;

FIG. 17a is a magnified cross-sectional view of a section of a fourth intermediate state during the execution of the second method for producing the electrical heating device in the first variant;

FIG. 17b is a cross-sectional view of the section from FIG. 17a in the second variant;

FIG. 18 is a side elevational section view of a first intermediate state during the execution of a third method for producing an electrical heating device;

FIG. 19 is a cross-sectional, partially exploded view of a section of a second intermediate state during the execution of the third method for producing the electrical heating device;

FIG. 20 is a cross-sectional view of a section of a third intermediate state during the execution of the third method for producing the electrical heating device; and

FIG. 21 is a cross-sectional view of a section of a fourth intermediate state during the execution of the third method for producing the electrical heating device.

### DETAILED DESCRIPTION OF THE INVENTION

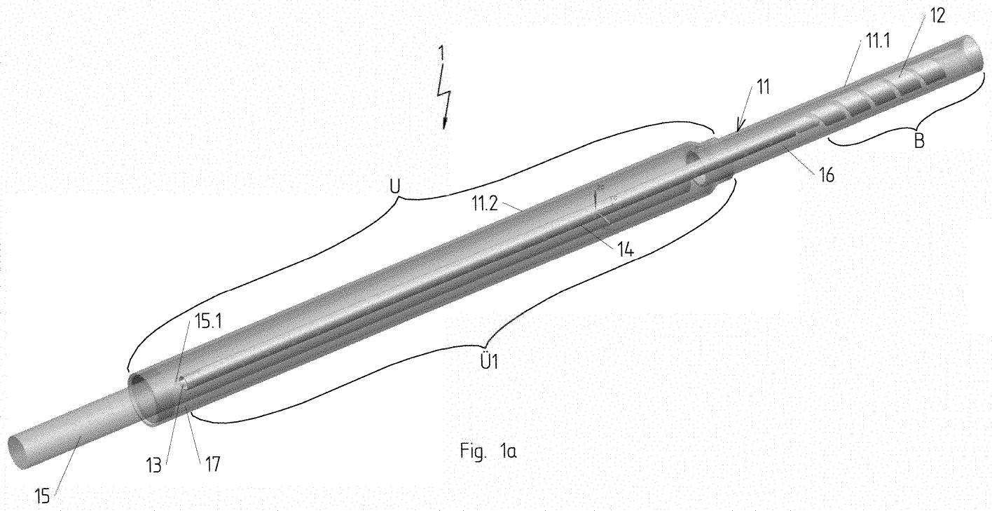

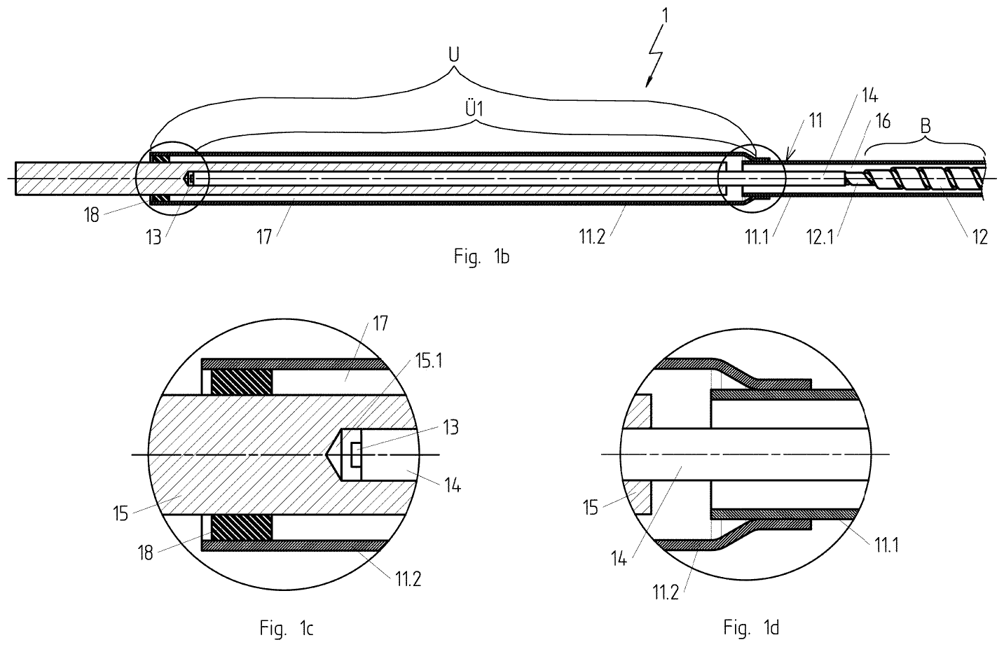

FIG. 1a shows a half of an embodiment of an electrical heating device 10, whose second half can be symmetric to the first half and FIG. 1b shows a longitudinal section of this half, which, however, is slightly offset from the center plane. The electrical heating device 10 has a multi-part tubular metal jacket 11 with a first part 11.1 of the multi-part tubular metal jacket 11 and a second part 11.2 of the multi-part tubular metal jacket 11, which has a larger open cross section than the first part 11.1 of the multi-part tubular metal jacket, which overlaps this part in some sections, and which is connected to it, as illustrated, in particular, by the detailed representation of FIG. 1d.

In the interior of the first part 11.1 of the multi-part tubular metal jacket 11 is the heated area B, which is formed by the section of an electrical heating elements 12, in which electrical current flows only through this part during operation. An electrically insulating material 16 shown transparent here ensures the electrical insulation relative to the multi-part tubular metal jacket 11.

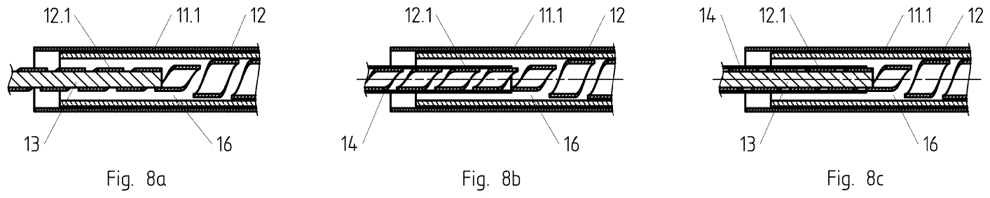

In the interior of the second part 11.2 of the multi-part tubular metal jacket 11, there is an unheated area U on the end side, which comprises an unheated transition area UE1. The unheated transition area UE1 is here formed by a section 12.1 of the electrical heating element 12, which is more tightly coiled than the electrical heating element 12 in the heated area, in which a connection wire 13 is inserted and pushed onto a connection sleeve 14, in which a connection pin 15 is held on its side in an opening 15.1, whose solid end section is in the unheated area U. This construction can be seen, e.g., by looking at FIGS. 1a and 1c. As can be seen from FIGS. 8a to 8c, however, not only the configuration with connection wire and connection sleeve described above and shown in FIG. 8c can be used, but optionally the connection wire 13, as shown in FIG. 8b, or the connection sleeve 14, as shown in FIG. 8a, can be left out.

Accordingly, during operation of the electrical heating device 10, electrical current flows in the unheated area U at least also through at least one connection wire 13, one connection sleeve 14, and/or one connection pin 15, which is in electrical contact with the electrical heating element 12, and the unheated area U also has an unheated transition area UE1, in which, during operation of the electrical heating device 10, electrical current flows simultaneously both through the at least one connection wire 13, the at least one connection sleeve 14, and/or the at least one connection pin 15 and also through a section 12.1 of the electrical heating element 12 running in the unheated transition area UE1, which is in electrical contact with the connection wire 13 and/or connection pin and has a smaller coil diameter. The unheated transition area extends into the first part 11.1 of the multi-part tubular metal jacket 11.

Also in the interior of the second part 11.2 of the multi-part tubular metal jacket 11 there is an electrically insulating material 17, which is shown transparent and ensures the insulation relative to the multi-part tubular metal jacket 11. On the end side, a plug 18 closes the second part 11.2 of the multi-part tubular metal jacket 11. The first part 11.1 of the multi-part tubular metal jacket 11 with the components of the electrical heating device 10 arranged therein and the second part 11.2 of the multi-part tubular metal jacket 11 with the components arranged therein of the electrical heating device 11 are each compressed in this example, but in different ways, in particular, to different degrees, preferably with a weaker compression of the second part 11.2 of the multi-part tubular metal jacket 11. However, the invention also comprises embodiments in which the second part 11.2 of the multi-part tubular metal jacket 11 with the components arranged therein is not compressed more.

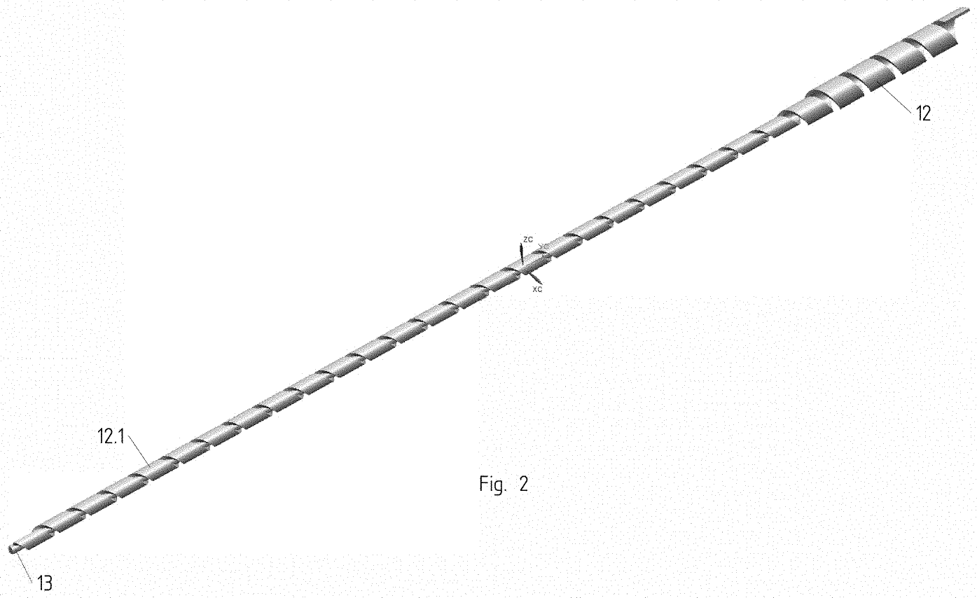

A method for producing such an electrical heating device is now described, wherein individual intermediate states are shown in FIGS. 2 to 6.

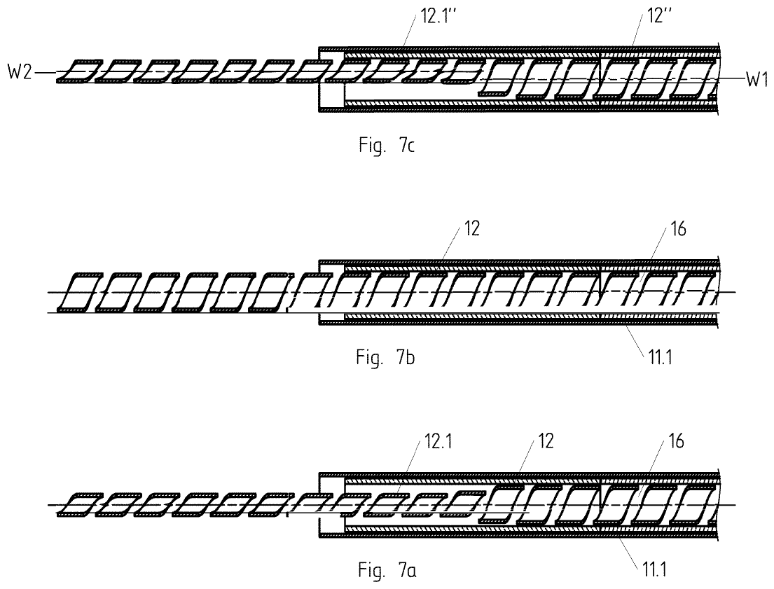

Initially, as shown in FIG. 2, a coiled electrical heating element 12 is provided, which has, in this embodiment, an end section 12.1 coiled with a smaller coil diameter, in which, on the end side, a connection wire 13, e.g., made from Cu or Ni, is pushed in and which is shown again in cross section in FIG. 7a.

Other variants of electrical heating elements 12′ and 12″ can be seen in FIGS. 7b and 7c, respectively, which illustrate, in particular, that the electrical heating element 12′ does not necessarily have to taper on the end side or that the electrical heating element 12″ has an end-side section 12.1″, which has a smaller coil diameter and is coiled about a different coil axis W2 than coil axis W1, about which the coils with greater coil diameter are coiled, which are in the heated area b in the finished electrical heating device, more specifically, about a coil axis W2 offset parallel to coil axis W1.

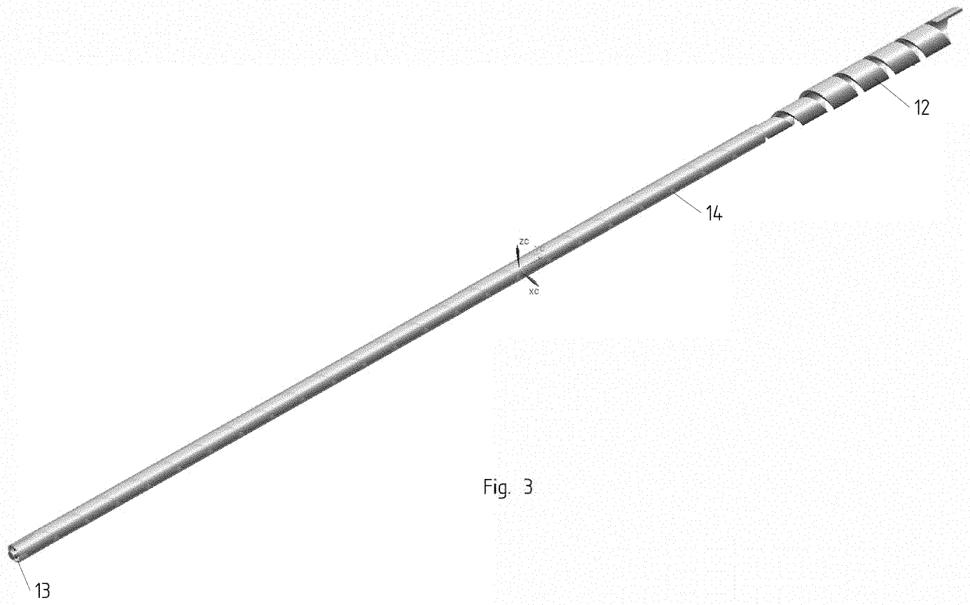

Starting from the intermediate state shown in FIG. 2, now a thin-walled, electrically conductive connection sleeve 14 is pushed onto the end-side section 12.1 of the electrical heating element 12, which leads to the intermediate state shown in FIG. 3.

The electrical heating element 12 prepared in this way with connection wire 13 and connection sleeve 14 is now pushed into the first part 11.1 of the multi-part tubular metal jacket 11. Electrically insulating material 16 in the form of a powder or granulate is poured in and the arrangement is compressed, which leads to the intermediate state according to FIG. 4, which already shows a “finished” electrical tubular heating element of a conventional design, in which—differently than in the known tubular heating elements—the connections projecting out of the tubular metal jacket on the end side in the electrical heating device are formed by a section of the electrical heating element with connection wire arranged thereon and/or connection sleeve arranged thereon, and thus form the unheated transition section for the completely finished electrical heating device according to the invention.

As the next step, an end-side part of the first part 11.1 of the multi-part tubular metal jacket 11 is cut together with the electrically insulating material 16. The reason for this is that, during the compression process of the first part 11.1 of the multi-part tubular metal jacket 11, higher pressures can be processed, which leads to a more desirable intimate press-contact fit of the pressed section 12.1 of the electrical heating element 12 with the connection wire 13 and connection sleeve 14. Accordingly, it can be useful to carry out this pressure step initially in a longer section, but nevertheless there is still a sufficiently good ability to fill the electrically insulating material 16. This is also the reason why the whole section 12.1 of the electrical heating element 12 is not just embedded and pressed together at first; in this case, the improvement of being able to fill the electrically insulating material 16 would be largely lost.

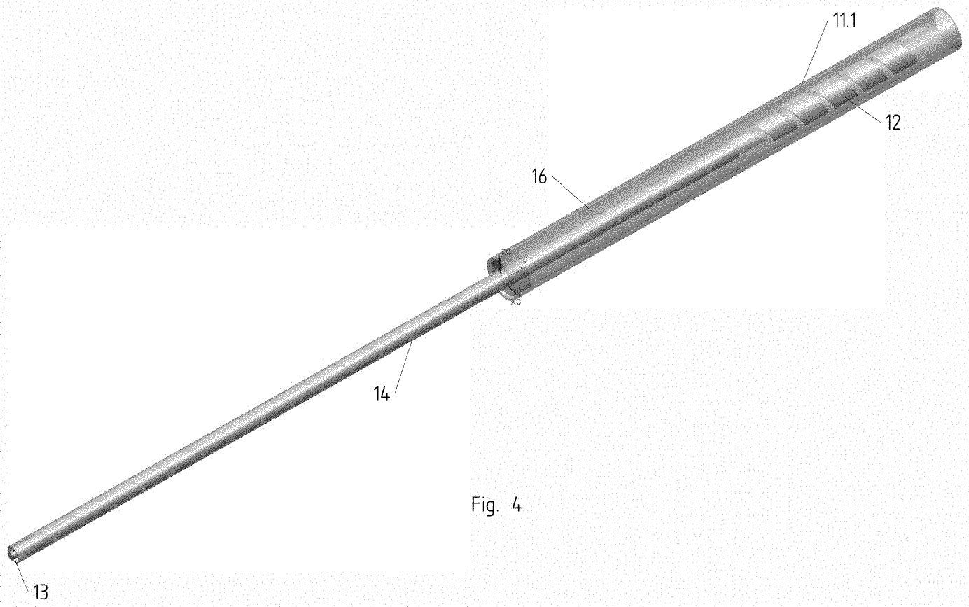

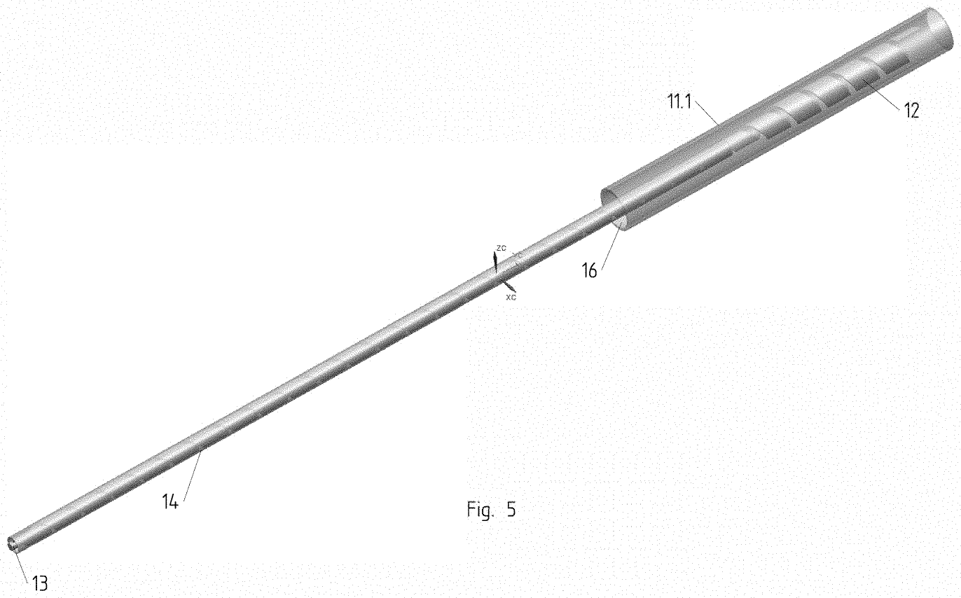

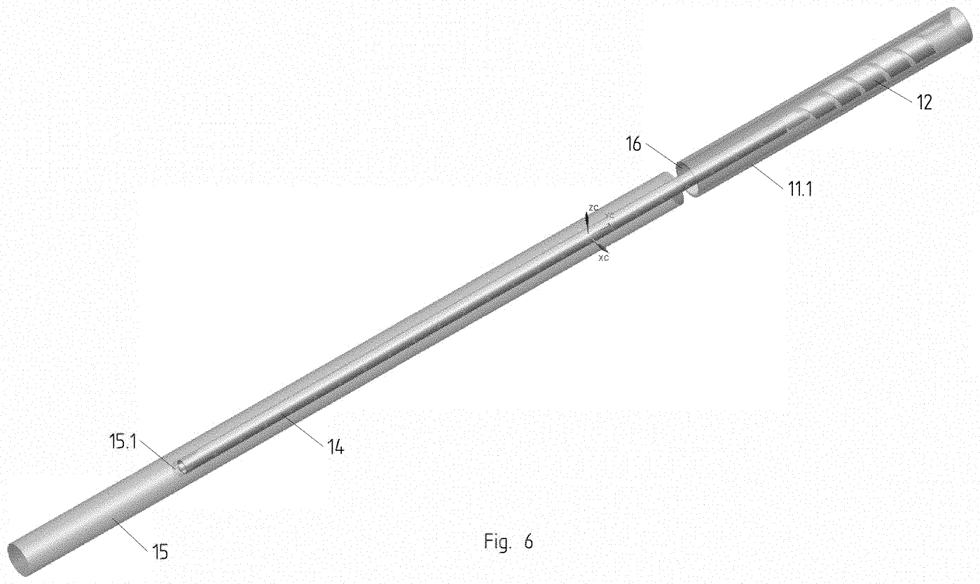

To get from the intermediate state of FIG. 5 to the intermediate state of FIG. 6, the connection pin 15 is pushed with its opening 15.1 onto the arrangement made from section 12.1 of the electrical heating element 12 with pushed-on connection wire 13 and pushed-on connection sleeve 14.

The finished electrical heating device 1 shown in FIGS. 1a to 1 d is obtained from the intermediate state according to FIG. 6 in that the second part 11.2 of the multi-part tubular metal jacket 11 is pushed on until it overlaps the first part 11.1 of the multi-part metal jacket 11 and is fixed to this part and this part is then filled with electrically insulating material 17, closed with the plug 18, and preferably appropriately compressed.

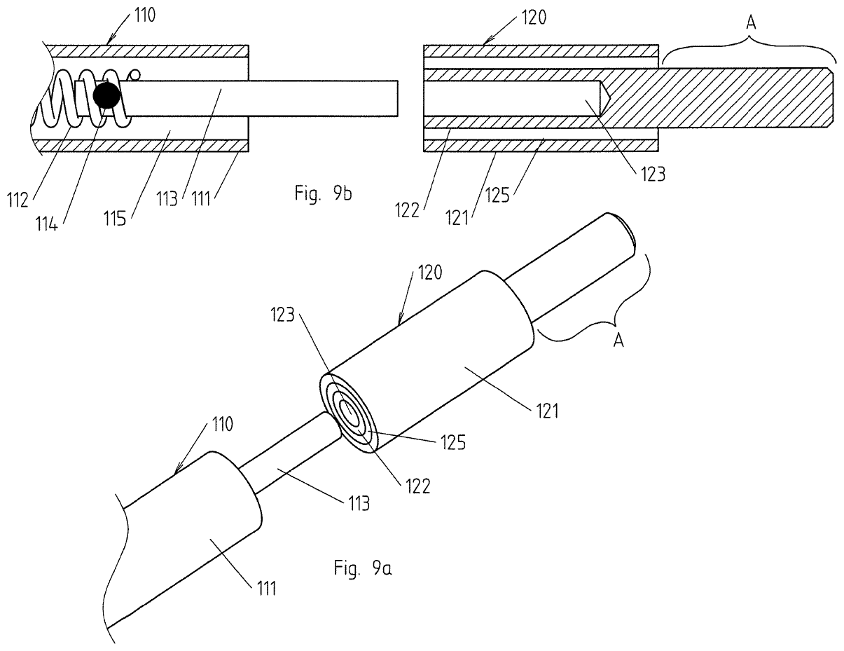

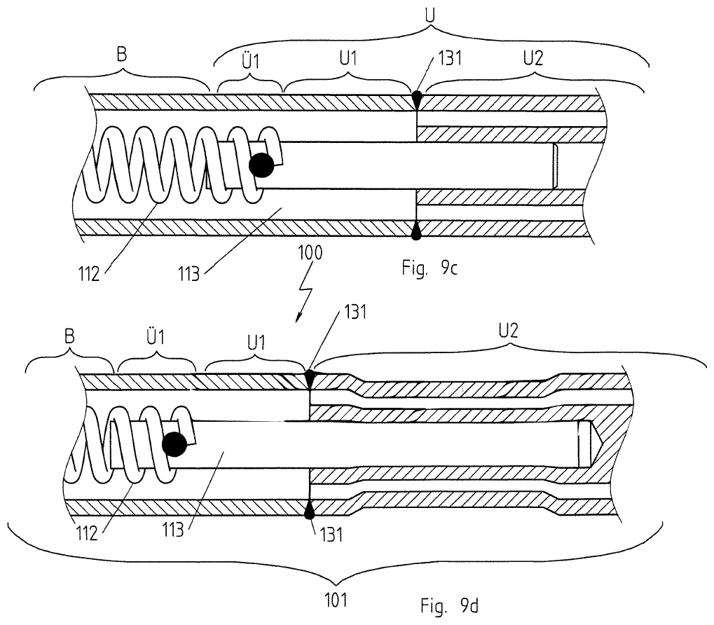

FIGS. 9a to 9f show different views of a section of a second embodiment of an electrical heating device 100 with multi-part tubular metal jacket 101. The not-shown section has an essentially identical construction.

Here, FIGS. 9a and 9b show the electrical heating device 100 in a first intermediate state of its production before joining the first part 111 of the tubular metal jacket 101 and the second part 121 of the tubular metal jacket 101.

The first part 111 of the tubular metal jacket 101 is here a part of an electrical heating device 110 produced in a known way, in whose interior there is an electrical heating element 112 in the shape of a coiled resistive wire, which is insulated by means of electrically insulating material 116 from the first part 111 of the tubular metal jacket 101. For the connection of the electrical heating elements 112, a connection wire 113, which projects out of the electrical heating element 112 on the end side, is pushed into the terminal coils of the electrical heating element 112 and in this example connected to it at the weld seam 114. The pushed-in section of the connection wire 113 thus defines an unheated transition area UE1, and the section of the connection wire 113, which runs within the first part 111 of the tubular metal jacket 101, forms a first part U1 of the unheated area U of the electrical heating device 100.

The second part 121 of the tubular metal jacket 101 is part of the second part U2 of the unheated area U of the electrical heating device 100. The second part U2 of the unheated area U is produced, in this example, from a section of a feedthrough 120, whose outer metal jacket is used as the second part 121 of the tubular metal jacket 101 of the electrical heating device 100, wherein, in its interior, an internal conductor 122 is arranged, which is electrically insulated by an electrically insulating material 125 from the outer metal jacket of the feedthrough 120. The internal conductor can preferably be made from nickel or copper. It is noted that such a feedthrough could also be mineral-insulated cables.

The feedthrough 120, which is produced in this example from extruded or band material, was cut to the length of this extruded or band material that corresponds to the sum of the desired length of the second part U2 of the unheated area and the desired length A of a connection of the electrical heating device 100. Furthermore, in the end side of the internal conductor 122 facing the first part 111 of the tubular metal jacket 101 there is a hole 123 for receiving the section of the connection wire 113 extending beyond the end side of the first part 111 of the tubular metal jacket and on the opposite side for forming the connection of length A, the feedthrough 120 and the electrically insulating material 125 is cut to this length of the outer metal jacket and preferably the surface of the internal conductor 122 is cleaned, e.g., by brushing, polishing, or ultrasonic processing. Here, the sequence in which these steps is performed is not important.

FIG. 9c shows a view of the longitudinal section from FIG. 9b after the joining of the first part 111 and the second part 121 of the tubular metal jacket 101. Here, the first part 111 and the second part 121 of the tubular metal jacket 101 were positioned against each other on the end sides and welded or soldered at the connection point 131.

Preferably, on the electrical heating device 100, as shown in FIG. 9c, another processing step is performed, whose result is shown clearly in FIG. 9d and FIG. 9f: another compression can also be realized as a local pressing process or repeated compression in the area of the second part 121 of the tubular metal jacket, preferably in the area in which the hole 123 with the section of the connection wire 113 arranged thereon is located, but at a distance from the connection point 131. This processing step can be concretely constructed, for example, as hexagonal crimping, in particular, through hammering, and is associated with two advantages:

The first advantage is that the electrical contact between the connection wire 113 and the internal conductor 122 is improved by a press-fit contact.

The second advantage that becomes clear especially by comparing the cutout enlargements of FIGS. 9e and 9f with each other is that, through the resulting axial pressing pressure, a nearly homogeneous transition area is produced between the electrically insulating material 115 and the electrically insulating material 125 and in particular, voids 132 and torn surfaces on the joined end sides can be filled.

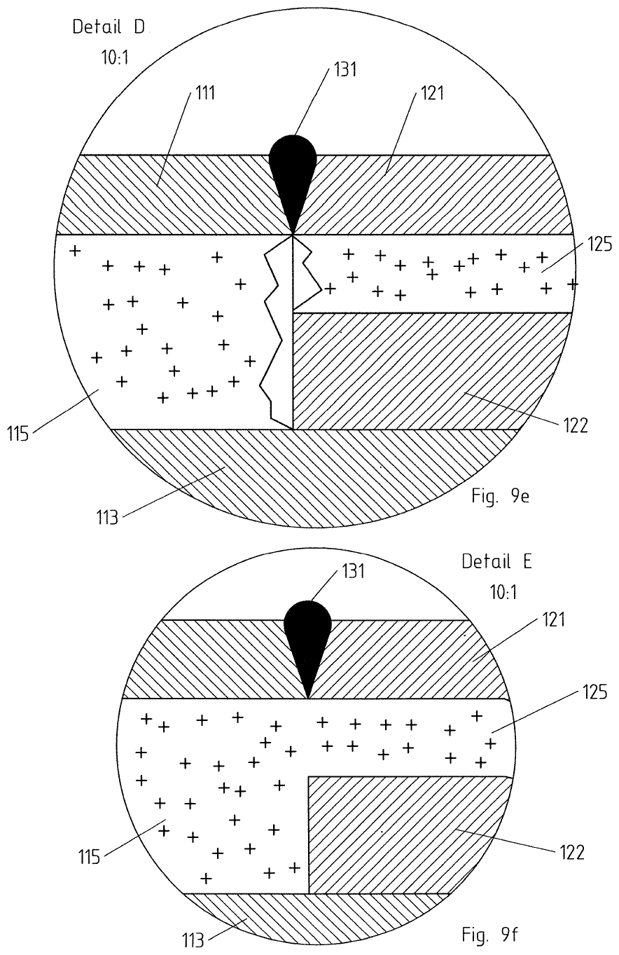

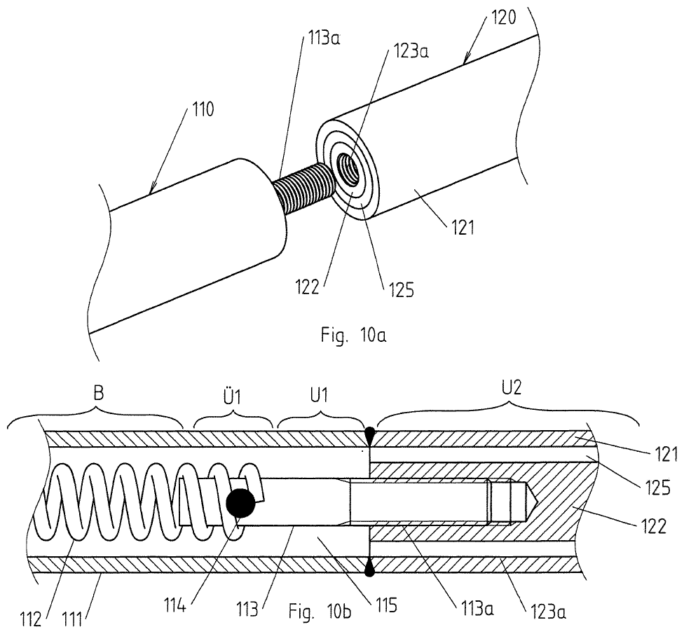

In a first variant of the electrical heating device 100, which is shown in FIGS. 10a and 10b, the only difference is that the connection wire 113 has a thread 113a and the hole 123 has a cut counter thread 123a. Accordingly, a connection is realized by screwing in the parts before the first part 111 of the tubular metal jacket 101 and the second part 121 of the tubular metal jacket 101 are welded or soldered to each other. All of the rest of the construction is identical, which is also why identical reference symbols are used.

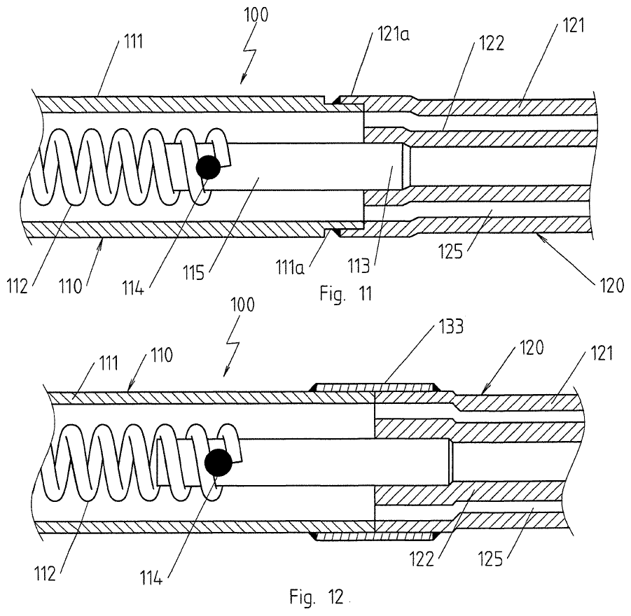

In a second variant of the electrical heating device 100, which is shown in FIG. 11, the only difference to the illustration shown in FIG. 9c is that the end area 111a of the first part 111 of the tubular metal jacket 101 is made thinner on its side facing the second part 121 of the tubular metal jacket 101 by material-removing processing on its outer side, while the end area 121a of the second part 121 of the tubular metal jacket 101 is made thinner on its side facing the first part 111 of the tubular metal jacket 101 by material-removing processing on its inner side, so that a section of the end areas 111a and 121a overlap each other. This leads to improved protection against the penetration of moisture.

Furthermore, the end area 111a is longer than the end area 121a, which has the result that the weld seam or solder bead fixing the connection is arranged in a recess and the diameter of the electrical heating device is not increased.

All of the rest of the construction is identical, which is also why identical reference symbols are used.

In a third variant of the electrical heating device 100, which is shown in FIG. 12, the only difference to the illustration shown in FIG. 9d is that the connection between the first part 111 of the tubular metal jacket 101 and the second part 121 of the tubular metal jacket 101 is the pushing on of a ring 133 and welding or soldering of the ring 133 at its edge with the second part 121 of the tubular metal jacket 101 and at its other edge on the first part 121 of the tubular metal jacket 101. This also leads to improved protection against the penetration of moisture.

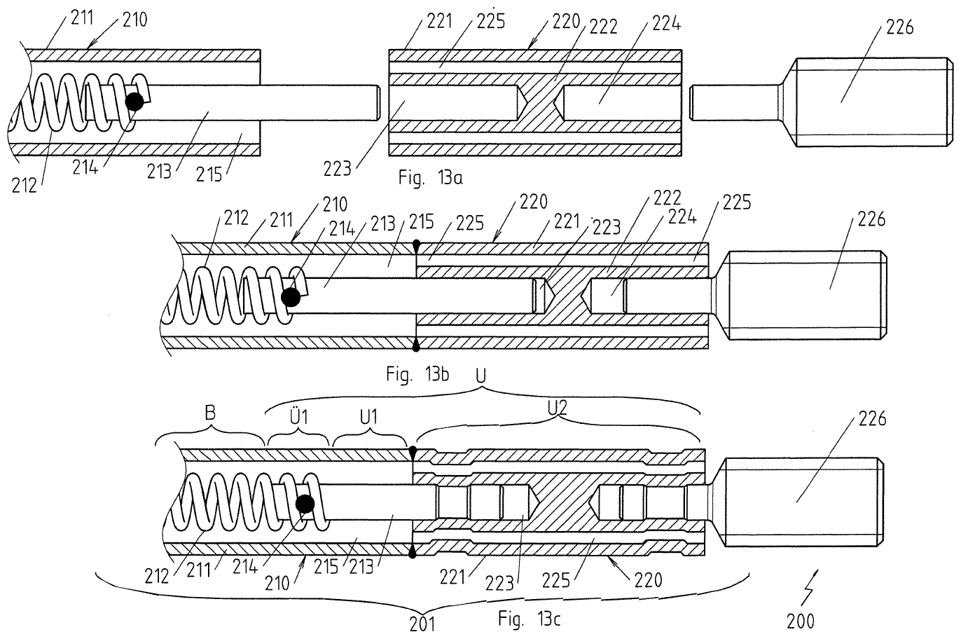

FIGS. 13a to 13c each show a longitudinal section through a section of a third embodiment of an electrical heating device 200, wherein FIG. 13a shows the state before the joining of the first and second part of the tubular metal jacket, FIG. 13b shows the state after the joining of the first and the second part of the tubular metal jacket, and FIG. 13c is after another local compression step, e.g., hammering in hexagonal crimping.

The first part 211 of the tubular metal jacket 201 is, like for the electrical heating device 100, part of an electrical heating device 210 produced in a known way, with an electrical heating element 212 arranged in the interior in the form of a coiled resistive wire, which is insulated by means of electrically insulating material 216 from the first part 211 of the tubular metal jacket 201. For the connection of the electrical heating element 212, a connection wire 213, which projects out from the electrical heating element 212 on the end side, is pushed into the terminal coils of the electrical heating element 212 and, in this example, connected to it at the weld seam 214. The pushed-on section of the connection wire 213 defines an unheated transition area UE1, and the section of the connection wire 213, which runs within the first part 211 of the tubular metal jacket 201, forms a first part U1 of the unheated area U of the electrical heating device 200.

The second part 221 of the tubular metal jacket 201 is part of the second part U2 of the unheated area U of the electrical heating device 200. The second part U2 of the unheated area U is also produced in this example from a section of a feedthrough 220, whose outer metal jacket is used as a second part 221 of the tubular metal jacket 201 of the electrical heating device 200, wherein, in its interior, an internal conductor 222 is arranged, which is electrically insulated from the outer metal jacket of the feedthrough by an electrically insulating material 225. The internal conductor can be produced preferably from nickel or copper.

The feedthrough 220, which is also produced in this example from extruded or band material, was here cut differently than for the electrical heating device 100 to the length of this extruded or band material that corresponds to the desired length of the second part U2 of the unheated area. Furthermore, for the electrical heating device 200, holes 223,224 are formed in both end sides of the internal conductor 222, in which on the one end side, the section of the connection wire 213 projecting past the end side of the first part 211 of the tubular metal jacket 201 is formed and is used on the opposite side for forming the connection 226, which is simply inserted into the hole and, as shown in FIG. 13c, forms a press-fit contact and is fixed by a pressing or compression step. Here, the sequence in which these steps is performed is not important.

FIG. 13b shows a view of the longitudinal section from FIG. 13a after the joining of the first part 211 and the second part 221 of the tubular metal jacket 201. Here, the first part 211 and the second part 221 of the tubular metal jacket 201 were positioned against each other at the ends and welded or soldered at the connection point 231.

Preferably, on the electrical heating device 200, as shown in FIG. 13b, another processing step is performed, whose result is clear in FIG. 13c: another compression, which could also be realized as a local pressing or repeated compression step, is performed in the area of the second part 221 of the tubular metal jacket, preferably in the area, in which the hole 223 is located with the section of the connection wire 213 arranged therein, but at a distance from the connection point 231. This processing step can be executed concretely, for example, as a hexagonal crimping step, in particular, by hammering, and is associated with the advantages already discussed above.

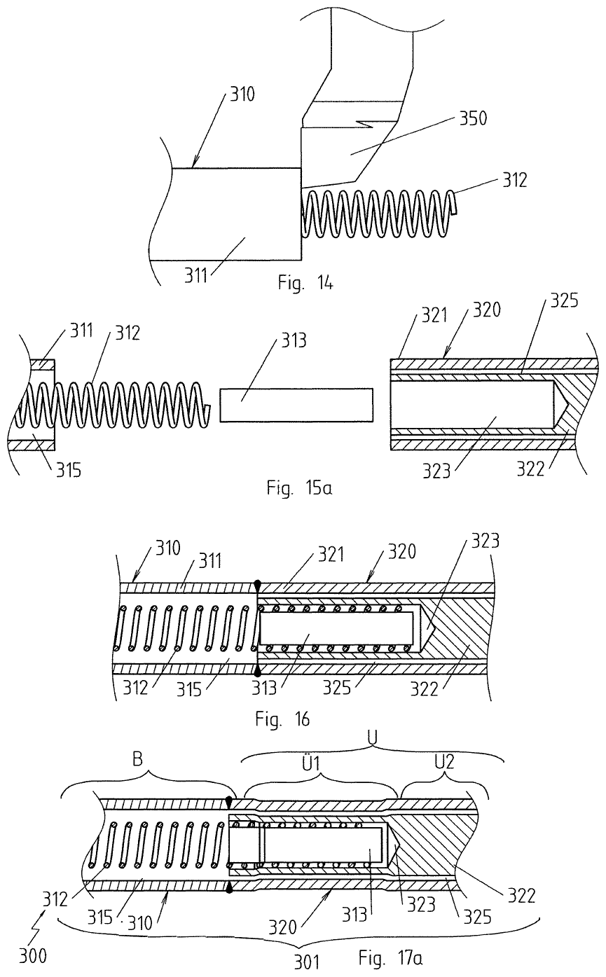

FIGS. 14 to 17 show different intermediate states during the execution of another method for producing an electrical heating device 300.

The electrical heating device 300 differs from the previously discussed electrical heating devices 10,100 and 200 basically in that, here, the first part 311 of the tubular metal jacket 301 has no first unheated section U1 and, in particular, also no unheated transition section UE1. Thus, it forms the heated area with electrical heating element 312 formed by a coiled resistive wire and electrically insulating material 315 only over its total length in its interior.

For this construction, it is possible to freely select the length of the heated area, in that the coiled heating element is provided with electrically insulating material and the tubular metal jacket is provided as extruded material. From this material, a piece with a length that corresponds to the length of the desired heated area plus the length of the unheated transition sections is cut. Then, the tubular metal jacket and the surrounding electrically insulating material are cut with a mold 350 to the length corresponding to the respective unheated transition sections, so that a part of the coiled electrical heating element, which is used for forming the unheated transition area UE1, extends past the end sides, as shown in FIG. 14.

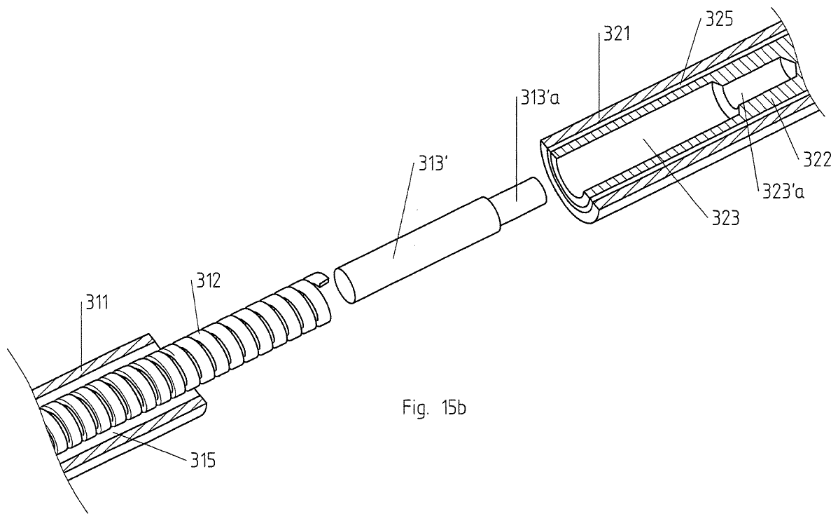

As can be seen in FIG. 15a, a connection wire 313 and a feedthrough 320, whose metal jacket forms the second part of the tubular metal jacket of the electrical heating device 300, is provided with internal conductor 322, hole 323, and electrically insulating material 325, which can be produced as explained above in connection with the electrical heating devices 100 and 200.

Then the connection wire 313 is inserted into the end-side section of the electrical heating element 312; this section of the electrical heating element 312 is inserted with inserted connection wire into the hole 323 of the internal conductor 322 and the first part 311 of the tubular metal jacket 301 is welded or soldered with the second part 321 of the tubular metal jacket 301 at the ends, which leads to the intermediate state shown in FIG. 16.

Another local compression process, e.g., by hammering in hexagonal crimping, is then performed in the unheated transition area UE1, whereby here, on one side, the homogenization of the electrically insulating material in the transition area between the first part 311 of the tubular metal jacket 301 and the second part 321 of the tubular metal jacket 301 can be realized and, on the other side, an intimate press-fit contact between electrical heating element 312, connection pin 313, and internal conductor 322 can be realized, as can also be seen in FIG. 17a.

In FIGS. 15b and 17b, the intermediate state corresponding to FIGS. 15a and 17a is shown in a second variant, respectively, which differ from the variants of FIGS. 15a and 17a only in that a stepped connection pin 313′ is used instead of the connection pin 313 and accordingly the hole 323 is replaced by a stepped hole 323′. The thinner section 313a′ of the stepped connection pin 313′ is here also subjected to a local compression process after it was inserted into the section 323a′ of the stepped hole 323′ and thus a press-fit contact is formed directly, while in the other section of the stepped connection pin 313′, a press-fit contact to the hole 323′ is realized only indirectly by means of the electrical heating element 312.

Because there are no other differences, the reference symbols from FIGS. 15a and 17a are still used, and for the description of the other aspects contained in FIGS. 15b and 17b, refer to the corresponding description in FIGS. 15a and 17a.

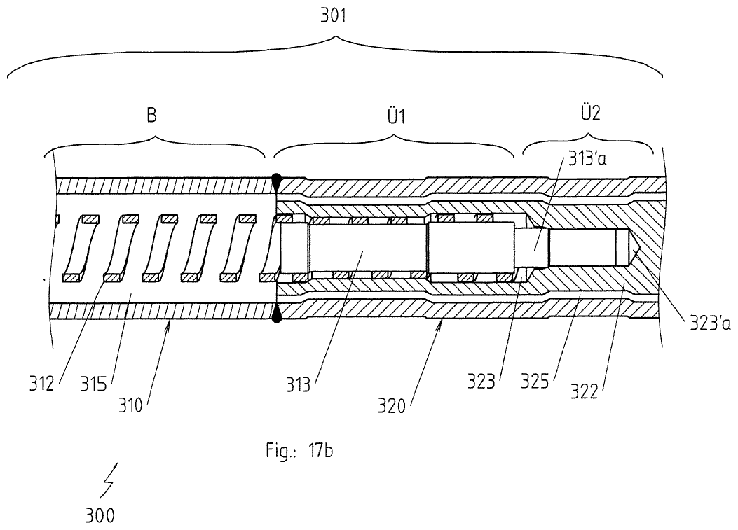

FIGS. 18 to 21 show different intermediate states during the execution of another method for producing an electrical heating device 400.

Just like for the electrical heating device 300, for the electrical heating devices 400, the first part 411 of the tubular metal jacket 401 has no first unheated section U1 and, in particular, also no unheated transition section UE1. Thus, the heated area is merely formed in its interior over its entire length with electrical heating element 412 formed here by a coiled resistive wire and electrically insulating material 415.

Like for the electrical heating device 300 and its production, the coiled heating element is provided with electrically insulating material and tubular metal jacket as extruded material and then cut on the end sides to the length of the tubular metal jacket corresponding to the respective unheated transition sections and the surrounding electrically insulating material with a mold 450, so that a part of the coiled electrical heating element, which is used for forming the unheated transition area UE1, extends past the end sides, as shown in FIG. 18.

As can be seen in FIG. 19, then a feedthrough 420, whose metal jacket forms the second part 421 of the tubular metal jacket 401 of the electrical heating device 400, is provided with internal conductor 422, on the end side in the annular groove 423 formed in the internal conductor 422 and electrically insulating material 425. Differently than in the corresponding step that is shown in FIG. 15, no separate connection wire is needed.

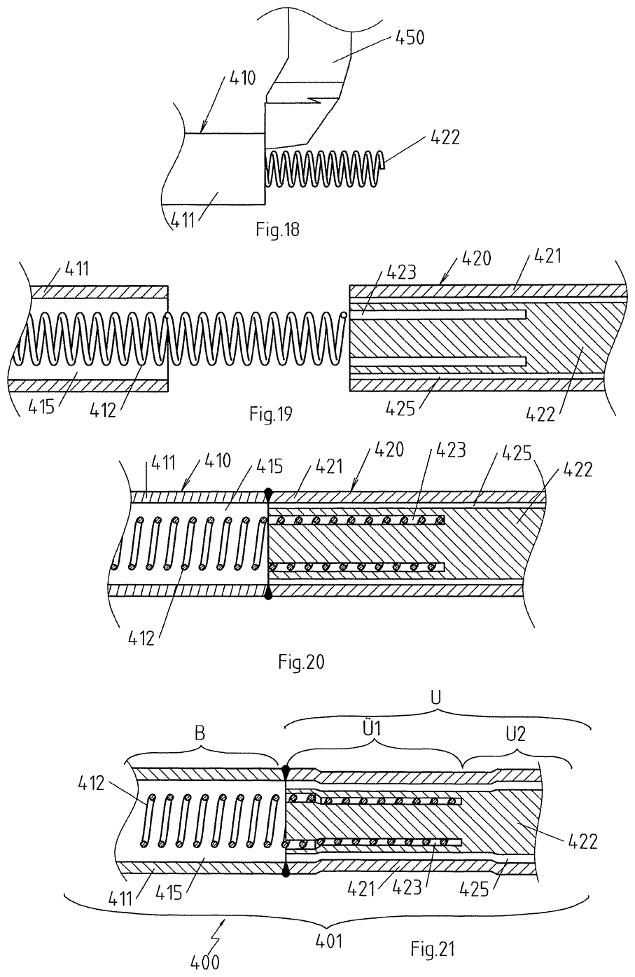

Then the end-side section of the electrical heating element 412 is inserted into the hole 423 of the internal conductor 422 and the first part 411 of the tubular metal jacket 401 is welded or soldered with the second part 421 of the tubular metal jacket 401 at the ends, which leads to the intermediate state shown in FIG. 20.

Another local compression process, e.g., by hammering in hexagonal crimping, is then performed in the unheated transition area UE1, by means of which, here, on one side, the homogenization of the electrically insulating material can be effected in the transition area between the first part 411 and the second part 421 of the tubular metal jacket and on the other side, an intimate press-fit contact can be realized between the electrical heating element 412 and internal conductor 422, as can also be seen in FIG. 21.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

### LIST OF REFERENCE SYMBOLS

10, 100, 110, 200, 210, 300, 400 Electrical heating device
11, 101, 201, 301, 401 Multi-part tubular metal jacket
11.1, 111, 211, 311, 411 First part (of the metal jacket)
11.2, 121, 221, 321, 421 Second part (of the metal jacket)
12, 12′, 12″, 112, 212, 312, 412 Electrical heating element
12.1, 12.1″ Section
13, 113, 213, 313 Connection wire
313′ Stepped connection wire
313a′ Section
14 Connection sleeve
15 Connection pin
15.1 Opening
16, 115, 215, 315, 415 Electrically insulating material
17, 125, 225, 325, 425 Electrically insulating material
18 Plug
111a End area
113a Thread
121a End area
123a Counter thread
114, 214 Weld seam
120, 220, 320, 420 Feedthrough
122, 222, 322, 422 Internal conductor
123, 223, 224, 323 Hole
323′ Stepped hole
323a′ Section
131, 231, 331, 431 Connection point
132 Cavity
133 Ring
226 Connection
350, 450 Mold
423 Annular groove
A Length (of a connection)
B Heated area
U Unheated area
U1 First part (of the unheated area)
U2 Second part (of the unheated area)
UE1 Unheated transition area
W1, W2 Coil axis

1. A method for producing an electrical heating device with an electrical heating element, which is arranged in an interior of a multi-part tubular metal jacket embedded in an electrically insulating material, wherein the electrical heating device has, within the multi-part tubular metal jacket,
on at least one end, an unheated area, in which, during operation of the electrical heating device, electrical current flows at least also through at least one connection wire, and at least one connection sleeve and at least one connection pin, which is in electrical contact with the electrical heating element and further has
a heated area, in which, during operation of the electrical heating device, electrical current flows only through a section of the electrical heating element running in the heated area,
wherein, in the method,
in a first method step, the heated area is produced and compressed in a first part of the multi-part tubular metal jacket, and
in a second method step performed independently from the first method step, at least one section of the unheated area is produced in a second part of the multi-part tubular metal jacket, and the first part and the second part of the multi-part tubular metal jacket are connected to each other.

2. The method for producing the electrical heating device according to claim 1, wherein
in the first method step
the section of the electrical heating element running in the heated area is positioned in the first part of the multi-part tubular metal jacket,
the electrically insulating material is inserted into an area of the first part of the multi-part tubular metal jacket, so that a section of the electrical heating element arranged in the first part of the multi-part tubular metal jacket is insulated by the electrically insulating material, and
the first part of the multi-part tubular metal jacket, in particular, the heated area, is compressed.

3. The method for producing the electrical heating device according to claim 1, wherein
the unheated area comprises an unheated transition area, in which, during operation of the electrical heating device, electrical current flows simultaneously both through the at least one connection wire and the at least one connection pin and also through a section of the electrical heating element running in the unheated transition area, which is in electrical contact with the at least one connection wire and the at least one connection sleeve and the at least one connection pin, and that, in the method, in the second method step performed independently from the first method step, at least one section of the unheated area including at least one part of the unheated transition area is created, in that a section of the electrical heating element is introduced with the at least one connection wire arranged thereon and the at least one connection sleeve arranged thereon and the at least one connection pin arranged thereon in the second part of the multi-part tubular metal jacket, in that the electrically insulating material is introduced into the second part of the multi-part tubular metal jacket, so that the section of the electrical heating element arranged in the second part of the multi-part tubular metal jacket is embedded in the electrically insulating material.

4. The method according to claim 1, wherein in the first method step, the at least one connection wire is brought into an electrically conductive connection with an end section of the electrical heating element, in particular, by introduction into a coiled end section of the electrical heating element, and that, in the first method step, the at least one connection sleeve is made from metal and is brought into an electrically conductive connection with the end section of the electrical heating element, in particular, by pushing, soldering, or welding the at least one connection sleeve onto the coiled end section of the electrical heating element.

5. The method according to claim 1, wherein in the second method step, the second part of the multi-part tubular metal jacket is compressed with components arranged therein a second compression, wherein the second compression is carried out so that, through an axial pressing pressure, a nearly homogeneous transition area is provided between the electrically insulating material in areas that were subjected to the compression in the first method step and the electrically insulating material in areas that were subjected to the second compression in the second method step.

6. The method according to claim 1, wherein the electrical heating element is coiled such that an end section of the electrical heating element has a smaller coil diameter than a section of the electrical heating element, which lies in the heated area in a finished electrical heating device.

7. The method according to claim 1, wherein when producing the second part of the multi-part tubular metal jacket, a feedthrough that has an internal conductor electrically insulated from an outer tube made from metal is used.

8. The method according to claim 1, wherein an internal conductor of the second part of the multi-part tubular metal jacket on a side facing the first part of the tubular metal jacket is machined with shape cutting, provided with an annular groove or drilled and that electrical contact to the electrical heating element is created directly or by means of the at least one connection wire, in that a section of the electrical heating element or the at least one connection wire is inserted and forms a press contact in a section of the internal conductor of the second part of the multi-part tubular metal jacket processed in this way.

9. An electrical heating device, which can be produced according to claim 1, with the electrical heating element, which has, in the interior, the multi-part tubular metal jacket, that has the first part and the second part, embedded in the electrically insulating material, wherein during operation of the electrical heating device, electrical current flows only through the section the electrical heating element running in the heated area, wherein the heated area is arranged in the first part of the multi-part tubular metal jacket and the unheated area is arranged in the second part of the multi-part tubular metal jacket.

10. The electrical heating device according to claim 9, wherein the unheated area comprises the unheated transition area, in which, during operation of the electrical heating device, electrical current flows simultaneously both through the at least one connection wire and the at least one connection sleeve and the at least one connection pin and also through the section of the electrical heating element running in the unheated transition area, which is in electrical contact with the at least one connection wire and the at least one connection sleeve and the at least one connection pin.

11. The electrical heating device according to claim 9, wherein characterized in that
the at least one connection wire is in an electrically conductive connection with an end section of the electrical heating element, in particular, inserted in a coiled end section of the electrical heating elements.

12. The electrical heating device according to claim 9, wherein
the at least one connection sleeve is made from metal and is brought into an electrically conductive connection with an end section of the electrical heating element, in particular, by pushing, soldering, or welding the at least one connection sleeve onto a coiled end section of the electrical heating element.

13. The electrical heating device according to claim 9, wherein
the electrical heating element is coiled such that an end section of the electrical heating element has a smaller coil diameter than a section of the electrical heating element, which is in the heated area for a finished electrical heating device.

14. The electrical heating device according to claim 9, wherein
characterized in that the second part of the multi-part tubular metal jacket has an open cross section, which can assume outer contours of an end section of the first part of the multi-part tubular metal jacket facing the second part at least after the compression in the first method step, is pushed onto and fixed on the end section of the first part of the multi-part tubular metal jacket.

15. The electrical heating device according to claim 9, wherein
characterized in that a part of the electrical heating element with the at least one connection wire arranged thereon and with the at least one connection sleeve arranged thereon is inserted from one side into the second part of the multi-part tubular metal jacket and the at least one connection pin with an opening for receiving the part of the electrical heating element with the at least one connection wire arranged thereon and with the at least one connection sleeve arranged thereon is inserted from an opposite side into the second part of the multi-part tubular metal jacket and is pushed with the opening onto the part of the electrical heating element with the at least one connection wire arranged thereon and with the at least one connection sleeve arranged thereon.
